(19) United States
(12) Patent Application Publication
(10) Pub. No.: US 2013/0036222 A1
(43) Pub. Date: Feb. 7, 2013

(54) INHERITABLE DIMENSIONS IN A SERVICE MODEL

(71) Applicant: COMPUWARE CORPORATION, Detroit, MI (US)

(72) Inventors: Murali Mogalayapalli, Novi, MI (US); Sriram Seshan, Farmington Hills, MI (US); William Noble, South Lyon, MI (US)

(73) Assignee: COMPUWARE CORPORATION, Detroit, MI (US)

(21) Appl. No.: 13/647,454

(22) Filed: Oct. 9, 2012

Related U.S. Application Data
(63) Continuation-in-part of application No. 12/814,749, filed on Jun. 14, 2010, now Pat. No. 8,291,059.

(51) Int. Cl. G06F 15/173

(52) U.S. Cl. 709/224

(57) ABSTRACT

A performance management tool is provided that monitors performance in a computing infrastructure in a computing environment. The performance management tool includes a service model that represents the computing infrastructure. The service model is a hierarchical tree structure comprised of a plurality of linked nodes, where each node in the tree structure represents a component of the computing infrastructure and has one or more properties of the component assigned thereto. Each node further includes an inheritance rule which defines how properties assigned to other nodes are inherited by the component. A dimension indexer module is configured to receive a request for properties associated with a particular node and operates to retrieve properties for the particular node from the tree structure, including at least one property not assigned to the particular node but inherited from another node in the tree structure in accordance with the inheritance rule assigned the particular node.

### CROSS-REFERENCE TO RELATED APPLICATIONS

This application is a continuation-in-part of U.S. patent application Ser. No. 12/814,749 filed on Jun. 14, 2010. The entire disclosure of the above application is incorporated herein by reference.

### FIELD

The present disclosure relates to inheritable dimensions in a service model. In particular, the present disclosure relates to techniques for determining a set of dimensions which relate to a particular type of node. The present disclosure further relates to techniques for determining a set of nodes to which a particular dimension pertains and which have a particular value assigned to the particular dimension.

### BACKGROUND

Many enterprises rely on complex computing infrastructures to drive their business. These computing infrastructures may include components such as distributed or web-based applications that are accessible to employees, customers, or parties related to the enterprise. These applications may be supported by various other components such as processors, memory devices, servers, server banks, and data centers. Furthermore, as the term “enterprise” can include any type of business or organization, other components may exist within the computing infrastructure. For example, the computing infrastructure of a banking enterprise may include automated teller machines (ATMs), while the computing infrastructure of an airline may include baggage tracking devices and check-in devices. In order to increase the effectiveness of their computing infrastructure, enterprises collect data regarding their computing infrastructure to better understand where problems exist or where more resources are available.

In order to monitor the computing infrastructure of an enterprise, a variety of tools that collect data relating to the computing infrastructure have been developed. For example, tools are used to measure the end-user response time of the applications, along with multiple metrics on the web servers, application servers, databases, and the physical servers that host the applications or application components. Metric data collected can include Quality of Service, CPU utilization, disk I/O rates, TCP transmission errors, etc.

In order to manage the collected data, an enterprise may utilize a database to manage the vast amounts of collected data. Databases, however, provide a very rigid structure that requires a developer to manually define database tables regarding specific components and to identify all the elements which pertain to each specific component. The rigidity of the databases makes adding new elements to a database complicated, as the developer must determine which tables will receive the new element and which tables do not receive the new element.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A performance management tool is provided that monitors performance in a computing infrastructure in a computing environment. The performance management tool includes a service model that represents the computing infrastructure. The service model is a hierarchical tree structure comprised of a plurality of linked nodes, where each node in the tree structure represents a component of the computing infrastructure and has one or more properties of the component assigned thereto. Each node further includes an inheritance rule which defines how properties assigned to other nodes are inherited by the component.

A dimension indexer module is configured to receive a request for properties associated with a particular node and operates to retrieve properties for the particular node from the tree structure, including at least one property not assigned to the particular node but inherited from another node in the tree structure in accordance with the inheritance rule assigned the particular node.

The dimension indexer can be further configured to receive a request for nodes in the tree structure having a particular property and operates to retrieve a listing of nodes having the particular property, including at least one node in the listing of nodes being identified using an inheritance rule.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustrating components of an example performance management tool according to some embodiments of the present disclosure;

FIG. 2 is a schematic illustrating example components of a service manager of the performance management tool of FIG. 1;

FIG. 3 is a drawing illustrating an example of a service model according to some embodiments of the present disclosure;

FIG. 4 is a drawing illustrating an example of nodes in a service model and the node definitions thereof according to some embodiments of the present disclosure;

FIG. 5 is a schematic illustrating example components of a service management module according to some embodiments of the present disclosure;

FIG. 6 is a schematic illustrating an example of a hash map that can identify specific nodes which have a given value assigned to a particular dimension according to some embodiments of the present disclosure;

FIG. 7 is a flow chart illustrating an example method for responding to a request to retrieve a set of dimensions pertaining to a particular type of node in a service model according to some embodiments of the present disclosure; and

FIG. 8 is a flow chart illustrating an example method for responding to a request to determine a set of nodes to which a particular dimension pertains and which have a particular value assigned to the particular dimension.

### DETAILED DESCRIPTION

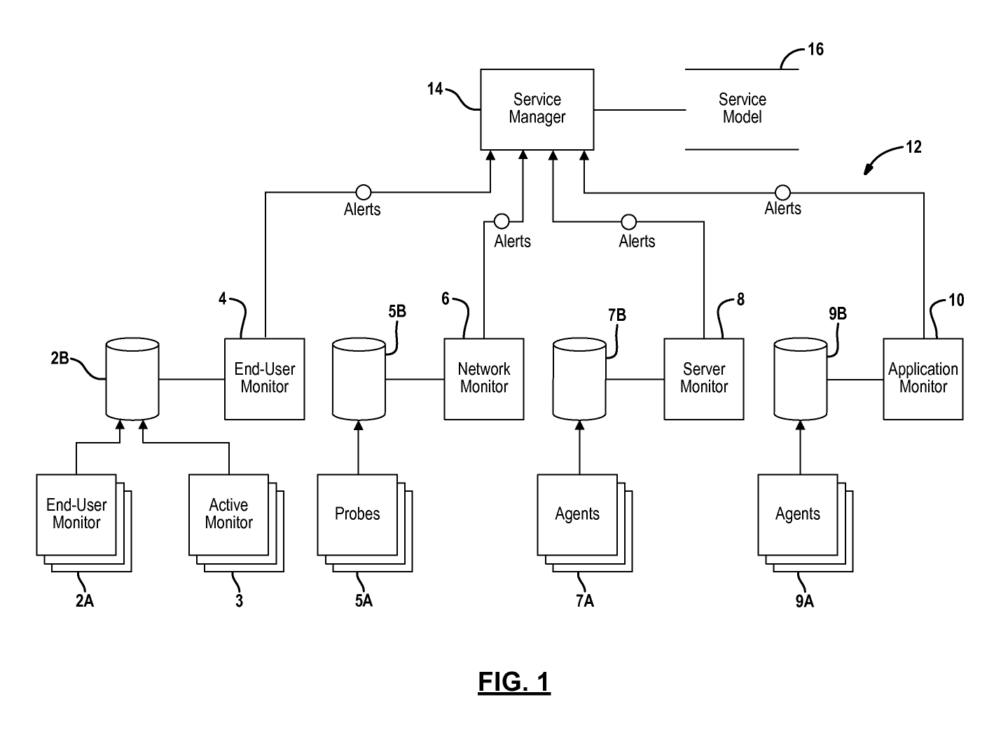

FIG. 1 depicts an exemplary performance management tool 12 that monitors performance of software applications and hardware devices in a computing environment. The performance management tool may be comprised generally of a service manager 14, a service model 16, and a plurality of different monitoring tools 18. The performance management tool 12 may include other components. The performance management tool 12 can be embodied as computer readable instructions residing on a computer readable medium, such that the computer readable instructions are executable by one or more processors.

The Vantage® software product commercially available from Compuware Corporation is an exemplary performance management tool 12. While the following description is provided with reference to the Vantage® software product and accompanying software offerings, it is readily understood that the teachings of this disclosure are applicable to other performance management tools. Moreover, it is understood that the Vantage® software product may be interfaced with monitoring tools from other third party vendors.

The service manager 14 processes and distills data from disparate sources to a present real-time view of quality and performance of software applications which comprise an enterprise's computing infrastructure. Data may be gathered using different types of monitoring tools 18 as will be further described below. The service manager 14 relies upon a service model 16 residing in a data store to understand the relationship between the data and a given application. More specifically, the service model 16 is a data structure that defines a computing infrastructure and the components thereof. The service model 16 can map components within the computing infrastructure to other related components. The service manager 14 then uses a dashboard concept to present service quality and performance indicators on a graphical user interface for each of the applications being monitored.

End-user monitoring may be accomplished using one of two methods. Agentless monitoring measures application response times experienced by each user of an application as well as other related performance metrics. In this approach, monitoring software 2A passively collects data anywhere in the network from one or more centralized locations. In other words, the monitoring software does not reside on the end-users computing device. The monitoring software 2A in turn stores the collected data in a database 2B associated with the tool. Such end-user monitoring software is available with the Vantage® product offering.

Active monitoring gauges response times for applications using monitoring software that typically resides on the end-users computing device or on a dedicated workstation. The monitoring software 3 simulates user experiences using synthetic transactions, thereby providing “control” measurements that are especially important for assuring performance when actual usage is low. Likewise, the collected data may be stored in database 2B for subsequent reporting and analysis. The ClientVantage® software available with the Vantage® product offering is an example of this type of monitoring tool.

Network monitoring tools monitor traffic on an enterprise's network. Network probes 5A are placed at different locations in the network. Each probe is a software component that passively collects data which may be used to derive performance metrics such as network throughput, bandwidth utilization, total bytes sent, server response time, etc. Other network performance related metrics are also contemplated by this disclosure. The collected data is then stored in a database 5B. The network monitoring tool may further include a software analysis component that analyzes and compiles the data for subsequent reporting. The NetworkVantage® software available with the Vantage® product offering is an example of this type of monitoring tool.

Server monitoring tools monitor metrics for physical servers (i.e., the hardware). Software agents 7A are placed on each of the devices being monitored. The software agents 7A collect data which may be used to derive performance metrics such as CPU utilization, memory utilization, disk space availability, and other server related performance metrics. The collected data is then stored in a database 7B. The server monitoring tool may further include a software analysis component that analyzes and compiles the data for subsequent reporting. The ServerVantage software available with the Vantage® product offering is an example of this type of monitoring tool.

Application performance monitoring tools monitor the performance and service availability of software applications running on physical servers. Software agents 9A are placed on the physical servers which host the software applications. The software agents 9A collect data which may be used to derive performance metrics including CPU utilization by an application, memory utilization by an application or other application related performance metrics. The collected data is then stored in a database 9B. The application performance monitoring tool may further include a software analysis component that analyzes and compiles the data for subsequent reporting. The VantageAnalyzer software available with the Vantage® product offering is an example of this type of monitoring tool.

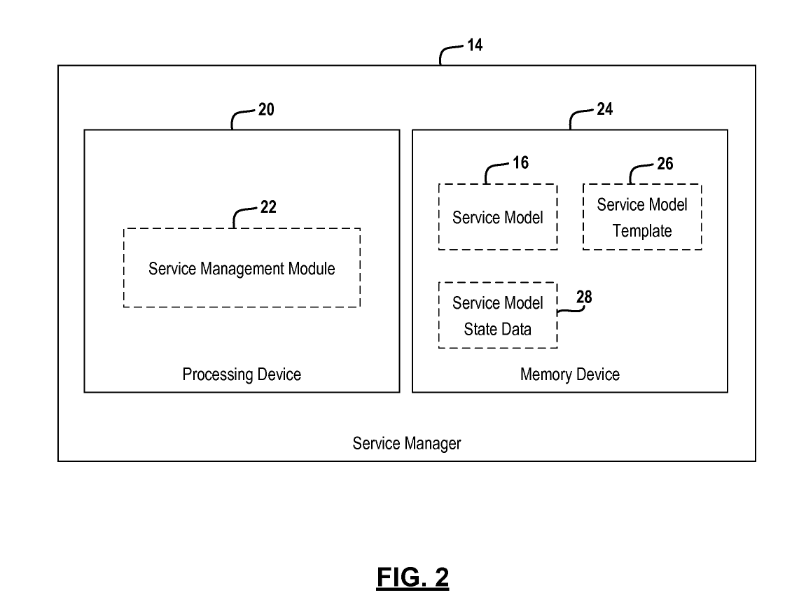

Referring now to FIG. 2, an example embodiment of the service manager 14 is illustrated. The service manager 14 can include a processing device 200 that executes the service management module 22 and a memory device 24 that stores various data that is referenced and maintained by the service management module 22. The performance management tool 12 can include any other suitable components.

The processing device 20 can include memory (e.g., read-only memory and/or random-access memory) that stores computer-executable instructions for performing the functions of the service management module 22 and one or more processors that execute the computer-executable instructions. In embodiments where the processing device 20 includes two or more processors, the two or more processors can operate in a distributed or individual manner. Furthermore, in these embodiments the two or more processors can reside in a single computing device or in multiple computing devices.

The memory device 24 can include one or more storage mediums. Examples of storage mediums that can be utilized in the memory device 24 include, but are not limited to, magnetic disk drives, optical disk drives, hard disk drives, flash memory drives. In some embodiments, the data that is stored by the memory device 24 includes one or more service models 16, one or more service model templates 26, and service model state data 28. Examples of the various types of data stored by the memory device 24 are provided below.

In general, the service management module 22 generates a service model 16 from a service model template 26. The service management module 22 further allows a user to configure the service model 16 in any suitable manner. The service management module 22 is further configured to receive monitoring data from various monitors, e.g., end-user monitor 4, network monitor 6, server monitor 8, and application monitor 10 (FIG. 1), and to update the service model state data 28 to reflect the received monitoring data. The service management module 22 also provides an interface for a user to request what properties are reportable for specific components within the service model and to request reports regarding components within the service model 16 based on the reportable properties. The service management module 22 can generate the requested reports and can present the reports for display in a dashboard.

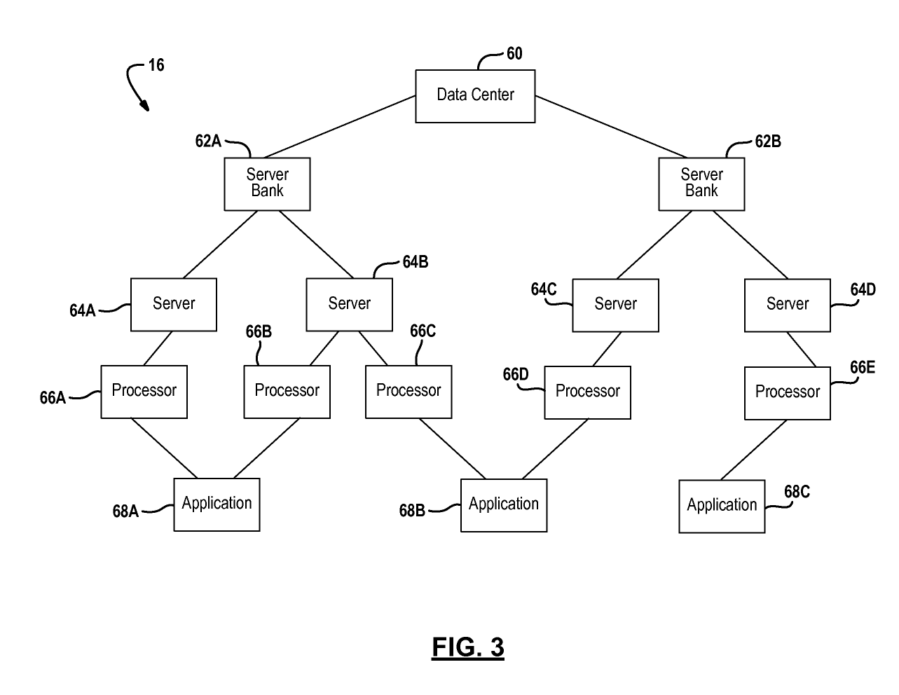

FIG. 3 illustrates an example service model 16 according to some embodiments of the present disclosure. In some embodiments, the service model 16 represents a computing infrastructure of an enterprise. In the illustrated example, the service model 16 is represented by an acyclic graph, i.e., a tree structure, comprised of a plurality of nodes. Each node in the service model 16 is a data representation of a component of the computing infrastructure. The components of a computing infrastructure can include “services” and “devices.” Devices can represent physical components of the computing infrastructure, while services can represent non-physical components of the computing infrastructure. In the illustrated example, the services include a data center, server bank, and applications, while the devices include servers and processors.

The illustrated service model 16 includes a data center node 60, server bank nodes 62-A and 62-B, server nodes 64-A, 64-B, 64-C, and 64-D, processor nodes 66-A, 66-B, 66-C, 66-D, and 66-E, and application nodes 68-A, 68-B, and 68-C. It is noted that the service model 16 may include any number or type of nodes. Furthermore, the service model 16 may include any number of layers. Furthermore, within each type of layer there may be more than one type of node.

In general, a node in a service model 16 is ancestral to and/or descendant from at least one other node in the service model 16. The term “ancestral’ refers to nodes which are hierarchically above a given node and have a direct pathway to the given node. For example, a parent node, a grandparent node, and a great-grand parent node would all be “ancestral” to a given node. In the illustrated example, the data center node 60 is ancestral to all the other nodes in the service model 16, i.e., the root node in this example. Put another way, the data center node 60 is a root node because there are no other nodes in the service model 16 which are ancestral to the data center node 60. In the illustrated example, server node 64-A is ancestral to the processor node 66-A and the application node 68-A. For purposes of explanation, a direct pathway from a given node to a node which is ancestral to the given node is referred to as an “ancestral pathway.”

The term “descendant” refers to nodes which are hierarchically below a given node and have a direct pathway to the given node. For example, a child node, a grandchild node, and a great-grandchild node would all be “descendant” from the given node. In the illustrated example, all of nodes are descendant from the data center node 60. Similarly, the processor node 66-B is descendant from the server node 64-B, the server bank node 62-A, and the data center node 60, but not from the application node 68-A or the processor node 66-A. For purposes of explanation, a direct pathway from a given node to a node which is descendant from the given node is referred to as a “descendant pathway.”

In some embodiments, a node may have more than one parent. In the illustrated example, the application node 68-B has two parent nodes, e.g., processor node 66-C and processor node 66-D. Furthermore, the node may more than one type of relationship with a parent node or may have different types of relationships with different parent nodes. The type of relationship between a parent node and child node can explain how the two nodes relate to one another. Examples of relationship types can be a component relationship, a dependency relationship, a value expression relationship, and a user count relationship. A child node is said to have a component relationship with its parent if the component represented by the child node is a subcomponent of the component represented by the parent node. A child node is said to have a dependency relationship with its parent node if the component represented by the child node is in some way dependent on the component represented by the parent node. A child node is said to have a value expression relationship with its parent node if the values expressed in the parent node are derived from the values expressed in the child node and other child nodes of the parent node. A child node is said to have a user count relationship with its parent node if the amount of users which access the component represented by the parent node is applicable to the component represented by the child node. It is noted that the foregoing is a non-limiting and non-exhaustive example of types of relationships.

The service management module 22 can generate the service model 16 and each node within the service model 16 according to a service model template 26 (FIG. 2). A service model template 26 can define the types of nodes which represent the components of the infrastructure, the structure of the different types of nodes, and the relationships between the different types of nodes. For example, a service model template corresponding to the service model 16 of FIG. 3 would include data center nodes, server bank nodes, server nodes, processor nodes, and application nodes. The service model template 26 may further define the relationships between the nodes, e.g., data center nodes are parents of the server bank nodes, and the type of relationship between the nodes, e.g., component relationship or dependency relationship. Furthermore, for each type of node within the service model 16, the service model template can include templates defining the structures of each type of node within the service model 16.

Each node also includes one or more “dimensions” and one or more “inheritance rules” explicitly defined therein. A “dimension” defines a property of a component. When a node is created, the node can have one or more dimensions explicitly defined in the template used to generate the node. For each specific node within the service model 16, the dimensions explicitly defined therein can be assigned specific values. For example, if the server nodes include a dimension that defines the type of the server, all of the server nodes may include a “type” dimension. For each server node, however, a value specific to the server represented by its corresponding node may be assigned to the dimension of the corresponding node. Thus, if the server represented by server node 64-A is an application server, the value of the “type” dimension of the server node 64-A can be assigned the value “Application Server.” In this manner, a user of the service manager 14 can search the service model 16 for specific nodes having specific values assigned to them, or can request to view the dimensions which pertain to a specific type of node. A dimension is said to “pertain” to a particular node or type of node, if the dimension is explicitly defined in the particular node or the template for the type of the particular node or if the dimension is inherited by the particular node.

The one or more inheritance rules explicitly defined within a given node or the template for a given node defines whether the given node is configured to inherit the dimensions of one or more of its parent nodes. When a given node “inherits” the dimensions of a parent node, the set of dimensions which pertain to the given node includes the dimensions which pertain to the parent node. It is noted that when a node inherits the dimensions of its parent node, the structure of the inheriting node is not altered. In other words, the dimensions which are inherited by a given node are not explicitly defined in the inheriting node but are still said to pertain to the given node. In this way, when a new dimension is defined in a node which is ancestral to a given node, the new dimension does not need to be explicitly defined in the given node. Furthermore, the inheriting node does not only inherit the dimensions which were explicitly defined in the parent node, but can also inherit the dimensions which the parent node was configured to inherit from its ancestors. Put another way, a first set of dimensions which pertain to the given node include a second set of dimensions which pertain to the parent node and the dimensions which are explicitly defined in the given node.

In some embodiments, more than one inheritance rule can be defined within a node. In these embodiments, the inheritance rules can each define whether a child node inherits dimensions from a parent node having a particular type of relationship with the child node. For example, a child node may be configured to inherit from parent nodes that have a component relationship with the child node but not from parent nodes which have a dependency relationship with the child node. The following XML snippet provides an example of definitions of inheritance rules:

### <Dimensions

InheritComponentParents=“true”

InheritDependencyParents =“false”

In heritValueExpression Parents =“true”

InheritUserCountParents =“true”

### </Dimensions>

As can be appreciated from the foregoing example, the child node is configured to inherit dimensions from parent nodes which have component, value expression, and user count relationship types, but not from parent nodes which have dependency relationship types.

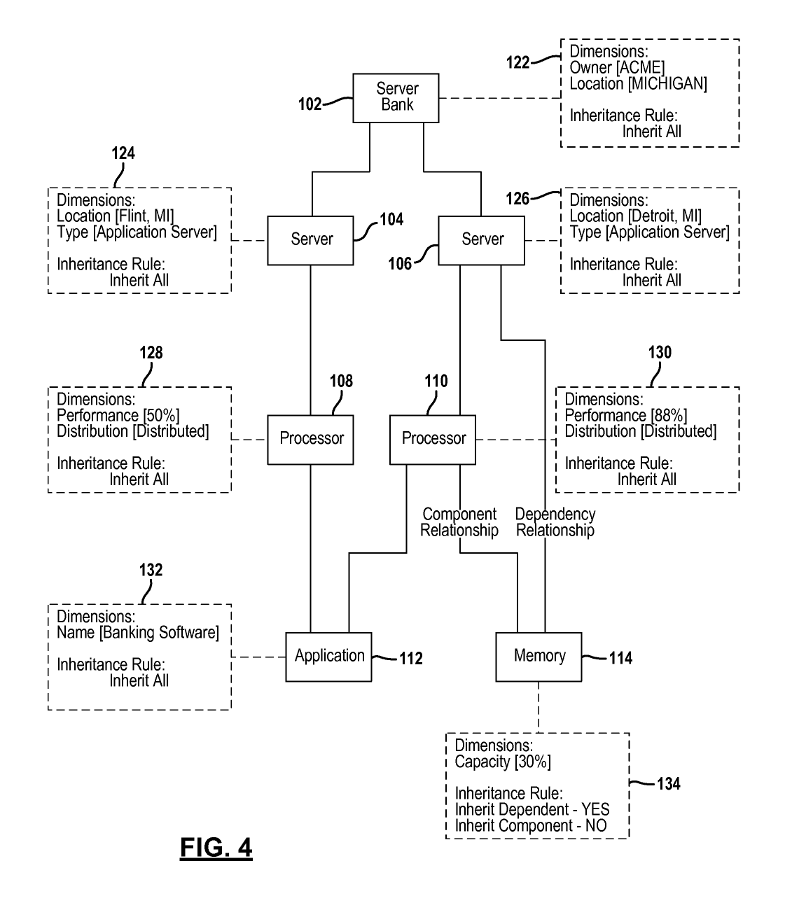

FIG. 4 illustrates an example of a plurality of nodes collectively defining at least a portion of a service model 100. In the illustrative example, the service model 100 includes a server bank node 102, server nodes 104 and 106, processor nodes 108 and 110, an application node 112, and a memory node 114. Each node has a node definition corresponding thereto. The node definitions are shown in dashed-line boxes. The node definitions illustrate the dimensions and inheritance rules explicitly defined within each node. It is noted that other types of information may be stored in the node definitions as well.

In the illustrated example, the server bank node 102 is at the highest level of the service model 100. The node definition 122 of the server bank node 102 includes an “owner” dimension and a “location” dimension. The node definition 122 of the server bank node 102 further includes an inheritance rule which indicates that it inherits from all parent nodes. It is noted that if the server bank node 102 is a root node of the service model 100, however, then the server bank node 102 would not inherit dimensions from any other nodes. In the illustrated example, the value “ACME” has been assigned to the “owner” dimension and the value “Michigan” has been assigned to the “location” dimension. Thus, in the example, the server bank is owned by “ACME” and is located in the state of Michigan.

In the illustrated example, server nodes 104 and 106 are the children nodes of the server bank node 102. In this example, the node definitions 124 and 126 of the server nodes 104 and 106 include a “location” dimension, a “type” dimension, and an inheritance rule explicitly defined therein. The values of the “type” dimension of both server nodes 104 and 106 have been assigned “Application Server,” thereby indicating that both servers represented by the server nodes 104 and 106 are application servers. The value of the “location” dimension in the node definition 124 of the server node 104 is assigned the value “Flint, Mich.” and the “location” dimension in the node definition 126 of the server node 106 is assigned the value “Detroit, Mich.” The inheritance rules defined in the node definitions 124 and 126 indicate that the server nodes 104 and 106 inherit the dimensions from parents having any type of relationship with the server nodes 104 and 106. Thus, the server nodes 104 and 106 can inherit the dimensions pertaining to the server bank node 102.

In some embodiments, when a node is inheriting the dimensions of its parent node, the dimensions pertaining to the parent node are “merged” with the dimensions explicitly defined in the inheriting node to obtain a set of dimensions pertaining to the inheriting node. The dimensions pertaining to the parent node include the dimensions explicitly defined in the parent node and dimensions which were inherited by the parent node from its ancestral nodes. Furthermore, when the set of dimensions pertaining to the parent node are merged with the dimensions explicitly defined in the inheriting node, the dimensions explicitly defined in the inheriting node can be given precedent over the dimensions pertaining to the parent node. In particular, if the inheriting node has a particular type of dimension defined therein, e.g., “location,” and the dimensions pertaining to the parent node also include the particular type of dimension, e.g., “location,” the inheriting node does not inherit the particular type of dimension from the parent. Rather, the dimension of the particular type explicitly defined in the inheriting node is included in the set of dimensions pertaining to the inheriting node, while the dimension of the particular type pertaining to the parent node is not added to the set of dimensions pertaining to the inheriting node. Applying the foregoing to the example of FIG. 4, the server nodes 104 and 106 would inherit the “owner” dimension from server bank node 102, but would not inherit the “location” dimension from the server bank node 102. Thus, the set of dimensions pertaining to server node 104 and server node 106 indicate that the servers are both application servers owned by ACME, but the server represented by server node 104 is located in Flint, MI and the server represented by server node 106 is located in Detroit, Mich.

The processor node 108 is the child of the server node 104 and the processor node 110 is the child of the server node 106. In the example, the node definitions 128 and 130 of processer nodes 108 and 110 include a “performance” dimension, a “distribution” dimension, and an inheritance rule indicating that the processor nodes 108 and 110 inherit from all types of parent nodes. In the illustrated example, the “performance” dimension of the processor node 108 is assigned a value of 50% and the “distribution” dimension is assigned a value of “distributed,” which can indicate that the processor represented by the processor node 108 is operating at 50% of its total processing capabilities and is working in a distributed manner with one or more other processors. Similarly, the “performance” dimension of the processor node 110 is assigned a value of 88% and the “distribution” dimension thereof is assigned the value “distributed.” The processor node 108 inherits the set of dimensions pertaining to server node 104 and the processor node 110 inherits the dimensions of the server node 106. Thus, both processor nodes 108 and 110 inherit the “location” and “type” dimensions explicitly defined in the respective server node 104 and 106, as well as the “owner” dimension of the server bank node 102. As will be discussed in greater detail below, a search performed by the service management module 22 (FIG. 2) requesting the performance values of the processors owned by ACME can yield the performance values of the processor nodes 108 and 110. It should be noted that the service management module 22 can locate the processor nodes 108 and 110 using the “owner” dimension, despite the “owner” dimension not being explicitly defined in the node definitions 128 and 130 of the processor nodes 108 and 110.

The application node 112 is the child of both the processor node 108 and processor node 110. Such a relationship indicates that the application represented by the application node 112 is executed by the processors indicated by the processor nodes 108 and 110. The node definition 132 of the application node 112 includes a “name” definition and an inheritance rule which indicates that the application node 112 inherits from all types of parent nodes. In some embodiments, when a node inherits from more than one parent node, and two or more of the parents include dimensions defining the same type of property, the inheriting node inherits the dimension only once, but the values assigned in each of the parent nodes may be propagated to the inheriting node. For example, the set of dimensions pertaining to the application node 112 include, inter alia, the “name” dimension explicitly defined in the node definition 132 of the application node 112 and the “performance” dimension, which was defined in node definitions 128 and 130 of the processor nodes 108 and 110. When the application node 112 inherits the “performance” dimension, the set of dimensions may only include one instance of the “performance” dimension, but may be assigned the values 50% and 88%. Thus, results of a search performed by the service management module 22 requesting all application nodes being executed by a processor that is operating at more than 75% of its total capacity would include the application represented by the application node 112. Similarly, results of a search performed by the service management module 22 requesting all application nodes being executed by a processor that is operating at less than 75% of its total capacity the would include the application represented by the application node 112.

The memory node 114 is a child of the processor node 110 and the server node 106. The memory node 114 has a component relationship with the processor node 110 and a dependent relationship with the server node 106. The node definition 134 of the memory node 114 explicitly defines a “capacity” dimension and two inheritance rules. The first inheritance rule indicates that the memory node 114 inherits the dimensions of parent nodes which the memory node 114 has a dependent relationship with. The second inheritance rule indicates that the memory node 114 does not inherit dimensions of parent nodes which the memory node 114 has a component relationship with. Thus, in the illustrated example the memory node 114 inherits the dimensions pertaining to the server node 106 but does not inherit the dimensions explicitly defined in the processor node 110. Accordingly, the set of dimensions pertaining to the memory node 114 include a “capacity” dimension, a “location” dimension, a “type” dimension, and an “owner” dimension. It is noted that based on the second inheritance rule, the “performance” dimension and the “distribution” dimension are not included in the set of dimensions pertaining to the memory node 114.

It is noted that the service management module 22 can update the service model 100 by adding new dimensions to one of the nodes and/or adding a new node to the service model 100. In this way, the service management module 22 does not need to change the node definitions of the other nodes in the service model 100. It is further noted that the example of FIG. 4 is provided for context and not intended to be limiting. The types of nodes, relationships between nodes, types of dimensions, and inheritance rules are all provided for example only and will vary from service model 16 to service model.

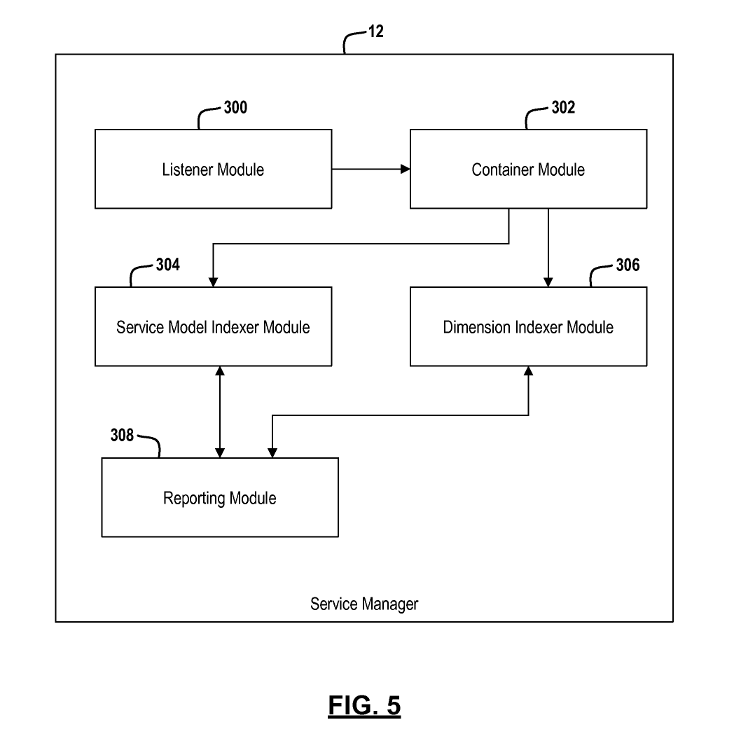

Referring now to FIG. 5, an example embodiment of the service management module 22 is illustrated. The example service management module 22 can include a listener module 300, a container module 302, a node indexer module 304, a dimension indexer module 306, and a reporting module 308. The service management module 22 may be configured to include other modules which are not shown. Furthermore, some of the modules disclosed herein may be combined into a single module and some modules may be comprised of two or more sub modules.

In some embodiments, the listener module 300 maintains and updates the service model 16, the service model template 26, and the service model state data 28. With respect to the service model state data 28, the listener module 300 receives monitoring data from one or monitors and/or user input from a user. The monitoring data can include one or more values and an indication of which component in the computing infrastructure the one or more values pertain. For example, the server monitor 8 may provide monitoring data indicating a performance value corresponding to a specific processor of a specific server. The listener module 300 provides the monitoring data to the container module 302 and instructs the container module 302 to update the service model state data 28 to reflect the monitoring data.

The listener module 300 can further receive requests to modify the configuration of the service model 16 and/or the service model template 26. In particular, the listener module 300 can receive requests to create, modify, update, and/or delete nodes within the service model 16. The listener module 300 can receive such requests from a user via, for example, a graphical user interface. An example request may include a request to add a new type of node to the service model 16 or to modify the dimensions within a preexisting node in the service model 16. For example, referring to the service model 16 of FIG. 3, the listener module 300 may receive a request to add disk node at the same level of the processor nodes 66-A, 66-B, 66-C, 66-D, and 66-E, such that the disk nodes are the children nodes of one or more of the server nodes 64-A, 64-B, 64-C, and 64-D. In another example, the listener module 300 may receive a request to add a new dimension to the processor nodes. The listener module 300 provides the requested configuration changes to the container module 302 and instructs the container module 302 to update the service model 16 and/or the service model template 26 to reflect the configuration changes.

The container module 302 is the container for the service model 16 and/or the service model template 26. When the container module 302 receives an instruction to update the service model state data 28 with a received value, the container module 302 identifies the particular node in the service model 16 to which the received value pertains and assigns the received value to the corresponding dimension of the particular node. The received value represents a state of a component represented in the service model 16, and is, therefore, considered service model state data 28 once assigned to a dimension of the particular node.

When the container module 302 receives an instruction to update the configuration of the service model 16, the container module 302 updates the service model 16 and/or the service model template 26 to reflect the requested update. Non-limiting examples of configuration updates include adding a new type of node to the service model 16, adding a new node to the service model 16, and adding new dimensions to a particular type of node. Other types of configuration updates can be performed by the container module 302 and are within the scope of the present disclosure.

When a new type of node is to be added to the service model 16, the container module 302 updates the service model template 26 to include the new type of node. The foregoing can include defining the level within the service model 16 at which the new type of node is located, the types of nodes that will be parents to the new type of node and the relationships therewith, the types of nodes that will be children to the new type of nodes and the relationships therewith, the dimensions that are initially explicitly defined in the new type of node, and the inheritance rules of the new type of node. The container module 302 may also update the definitions of the parent and children nodes of the new type of node in the service model template 26, as the parent and children nodes will have new relationships as a result of the new type of node being added.

When a new node is to be added to the service model 16, the container module 302 utilizes the service model template 26 to generate a new node. The container module 302 can define the references to the specific parent and child nodes of the new node, and can assign specific values to the dimensions of the new node, provided that such values are known at the time of creation. Once the new node is created, the new node can be stored in the memory device 24 as part of the service model 16.

When a new dimension is to be added to a particular type of node, the container module 302 can update the service model template 26 and the service model 16 to reflect the new dimension. To update the service model template 26, the container module 302 modifies the definition of the particular type of node to include the new dimension. The foregoing may include defining the type of values that can be assigned to the dimension, e.g., strings, integers, or floating point decimals. After the service model template 26 is updated, any new nodes of the particular type that are generated will include the new dimension. Nodes of the particular type which have already been generated and added to the service model 16, however, may need to be updated as well to reflect the new dimension. In order to update these nodes, the container module 302 retrieves all the nodes of the particular type in the service model 16 and adds the dimension in the node definition of each node.

Whenever the container module 302 performs a configuration update, the container module 302 notifies the node indexer module 304 and the dimension indexer module 306. The node indexer module 304 is an indexer that provides access to nodes by their identifiers. Thus, if a specific node is requested by, for example, the reporting module 308, the node indexer module 304 can retrieve and provide the specific node and its corresponding service model state data 28. Alternatively, the node indexer module 304 can provide pointers to the specific node and its corresponding service model state data. In some embodiments, the node indexer module 304 can maintain one or more indexes which identify each node in the service model 16 and its corresponding service model state data 28. For example, the node indexer module 304 can maintain a hash map that receives a node identifier as a key and outputs pointers to a specific node and its corresponding service model state data 28. When a node is added or deleted from the service model 16 or the service model state data 28 of a particular node is updated, the service model indexer can update the index, e.g., hash map, to reflect any new changes.

The dimension indexer module 306 is an indexer that responds to dimension-related queries. Examples of dimension-related queries include requests to retrieve a set of dimensions pertaining to a particular type of node and requests to retrieve nodes with specific values assigned to one or more dimensions. The dimension indexer module 306 can determine a response to the query by analyzing the service model 16 and/or the service model template 26 and/or by referencing one or more caches maintained by the dimension indexer module 306.

In some embodiments, the dimension indexer module 306 can maintain a dimension cache which stores the dimensions which pertain to each type of node, such that the sets of dimensions pertaining to each type of node can be predetermined and stored in the dimension cache. Thus, when the dimension indexer module 306 receives a request for a set of dimensions pertaining to a specific type of node, the dimension indexer module 306 can look up the set of dimensions from the dimension cache. In these embodiments, when the configuration of the service model 16 and/or service model template 26 is updated, the dimension indexer module 306 can update the dimension cache to reflect the changes to the service model 16 and/or the service model template 26.

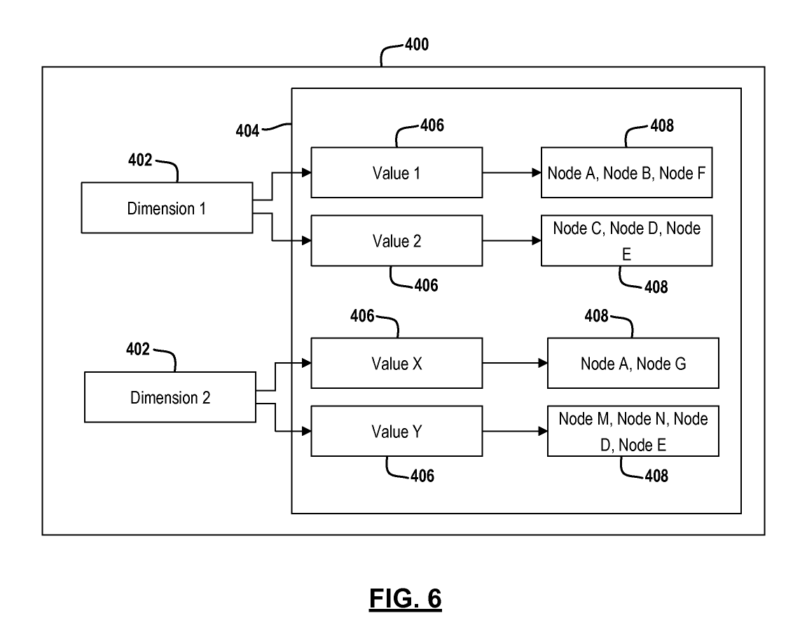

In some embodiments, the dimension indexer module 306 maintains a specific value cache that enables the dimension indexer module 306 to identify specific nodes which have a given value assigned to a particular dimension. In some of these embodiments, the specific value cache can be implemented in the form of a hash map. FIG. 6 illustrates an example of a hash map 400. The initial keys 402 to hash map 400 are dimension names corresponding to the different types of dimensions. For each type of dimension, the hash map 400 includes a secondary map 404. The secondary keys 406 to the hash map are values corresponding to the type of dimension. The secondary map 404 maps the different values to the nodes to which the value pertains. Thus, if the dimension indexer module 306 receives a request to identify nodes which have “value 1” assigned to “dimension 1,” the dimension indexer module 306 can reference the hash map 400 to determine that that “Node A,” “Node B,” and “Node F” have the value 1 assigned to “dimension 1.” Similarly, if the dimension indexer module 306 receives a request to identify nodes which have “value 1” assigned to “dimension 1,” and “value x” assigned to “dimension 2,” the dimension indexer module 306 can reference the hash map 400 to determine that “Node A” is the only node which has “value 1” assigned to “dimension 1” and “value x” assigned to “dimension 2. The hash map 400 of FIG. 6 is provided for an example of a cache only. Furthermore, the cache maintained by the dimension indexer module 306 can be implemented in any suitable manner.

The dimension indexer module 306 can maintain additional caches as well. The additional caches can include a node cache, a descendant cache, an ancestor cache, and a value cache. The node cache can identify the dimensions which are explicitly defined in each type of node. The descendant cache can identify the descendant nodes of each specific node in the service model 16, such that the descendant nodes are the nodes which are configured to inherit from the specific node. The ancestor cache can identify the ancestor nodes of each specific node in the service model, such that the ancestor nodes are the nodes which the specific node is configured to inherit from. The value cache can identify the set of all possible dimensions and all possible values for each of the dimensions. The list of caches is provided for example and other types of caches may be maintained by the dimension indexer module 306.

Referring back to FIG. 5, the reporting module 308 provides an interface for a user to request reports regarding a computing infrastructure and the state thereof. One feature of the reporting module 308 is that it allows the user to provide dimension-related queries to the service management module 22. For example, in some embodiments, the reporting module 308 may present a graphical user interface in which a user can manually enter one or more dimension-related queries. The reporting module 308 receives the dimension-related queries and provides them to the dimension indexer module 306. The dimension indexer module 306 returns the requested response to the reporting module 308, which in turn can provide the requested response to the user. For example, the dimension indexer module 306 can display the requested response in the graphical user interface. It is noted that the reporting module 308 can perform other reporting functions as well. For example, the reporting module 308 can generate one or more dashboards that display service model state data 28 corresponding to one or more particular nodes.

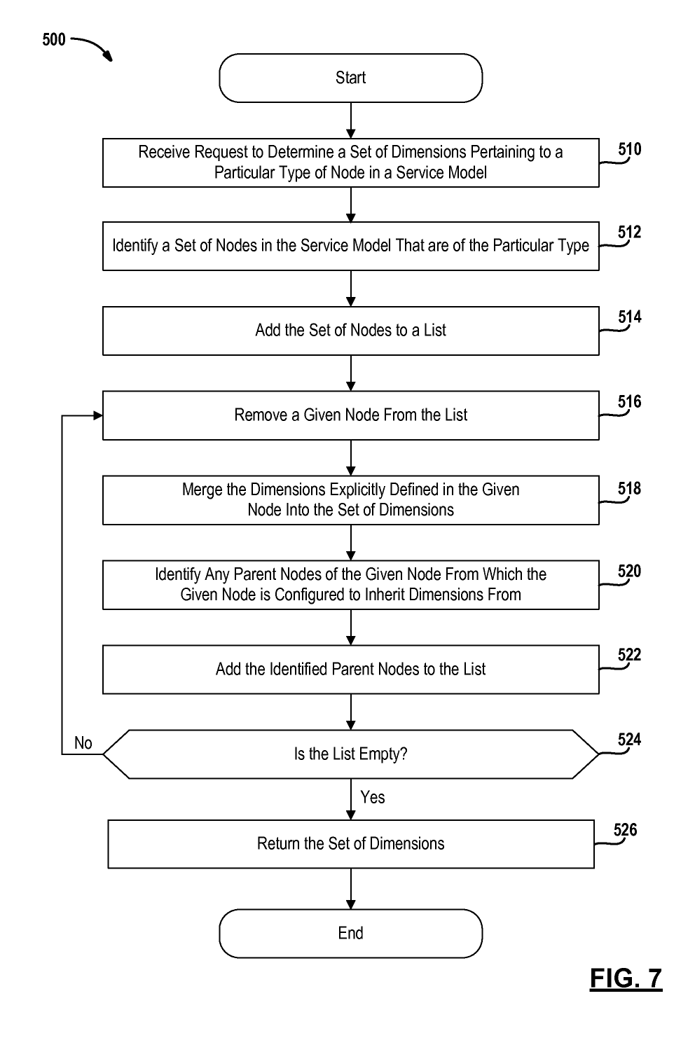

Referring now to FIG. 7, an example method 500 for responding to a request to retrieve a set of dimensions pertaining to a particular type of node in a service model is illustrated. For purposes of providing context to the description of the method 500, reference is made to the example service model 100 of FIG. 4.

In some embodiments, the method 500 is performed by the dimension indexer module 306. The dimension indexer module 306 may access the memory device 24 which maintains the service model 100. At operation 510, the dimension indexer module 306 receives the request to retrieve the set of dimensions pertaining to a particular type of node in the service model 100. For example, the dimension indexer module 306 may receive a request to retrieve the set of dimensions pertaining to the application nodes of the service model 100 (FIG. 4).

At operation 512, the dimension indexer module 306 can identify a set of nodes in the service model 100 that are of the particular type. Thus, in the example referenced above, the dimension indexer module 306 can identify application node 112 as the nodes having the type “Application Node.”

At operation 514, the dimension indexer module 306 can add the identified set of nodes to a list of nodes. The list of nodes can be, for example, a linked list, a stack, or any other suitable structure. Thus, in the example provided above, the dimension indexer 306 can add the application node 112 or a pointer thereto to the list of nodes.

At operation 516, the dimension indexer module 306 can remove a given node from the list of nodes. In some embodiments, the given node can be selected for removal in a first-in first-out manner. It is noted that the given node can alternatively be selected for removal in a last-in first-out manner or in any other suitable manner. During a first iteration on the service model 100, the dimension indexer module 306 removes the application node 112 from the list of nodes.

At operation 518, the dimension indexer module 306 merges the dimensions that are explicitly defined within the given node with the set of dimensions. As described above, the dimension indexer module 306 can merge the dimensions explicitly defined in the given node with the set of nodes by determining whether each particular dimension explicitly defined in the given node has already been added to the set of dimensions. If the particular dimension has not been added, then the particular dimension is added to the set of dimensions. Otherwise, the particular dimension is not added to the set of dimensions. As can be appreciated from FIG. 7, operations 516, 518, 520, 522, and 524 are performed in an iterative manner. Thus, during the first iteration, the set of dimensions is empty and the dimensions explicitly defined in the given node can be merged with the empty set of dimensions by adding the explicitly defined dimensions into the set of dimensions. During subsequent iterations, the dimensions explicitly defined in the given node are merged with the set of dimensions by only adding the explicitly defined dimensions that were not merged with the set of dimensions during a previous iteration. Accordingly, during the first iteration, the dimension indexer module 306 identifies the dimensions of application node 112, i.e., the “name” dimension, and adds the “name” dimension to the empty set of dimensions.

At operation 520, the dimension indexer module 306 identifies any parent nodes of the given node. The dimension indexer module 306 can request the identity of the parent nodes of the given node from the node indexer module 304. At operation 522, the identified parent nodes are added to the list. During the first iteration of the example provided above, the dimension indexer module 306 identifies processor nodes 108 and 110 as the parent nodes of application node 112 and adds the processor nodes 108 and 110 (or pointers thereto) to the list of nodes. It is noted that if the given node is a root node, the dimension indexer module 306 will not identify any parent nodes. In this scenario, no parent nodes are added to the list.

At operation 524, the dimension indexer module 306 determines whether the list of nodes is empty. In the example provided above, the dimension indexer added the processor nodes 108 and 110 to the list of nodes. Therefore, the list of nodes is not empty after the first iteration. If the list of nodes is not empty, the dimension indexer module 306 returns to operation 516 and removes the next node in the list (which then becomes the given node). The dimension indexer module 306 continues to iterate through the list of nodes until the list is empty. For example, during the second iteration, the dimension indexer module 306 can remove the processor node 108 from the list of nodes and identify the dimensions explicitly defined in the processor node 108, i.e., the “performance” dimension and the “distribution” dimension. As neither of these dimensions had been added to the set of dimensions during the first iteration, the “performance” dimension and the “distribution” dimension are added to the set of dimensions. Furthermore, the parent node of the processor node 108, i.e., the server node 104, is added to the list of nodes. During a third iteration, the processor node 110 is analyzed. As the “performance” dimension and the “distribution” dimension were merged with the set of dimensions during the second iteration, these dimensions are not added to the set of dimensions again during the subsequent iteration. The parent node of the processor node 110, i.e., server node 106, is added to the list of nodes during the third iteration. The method 500 will continue to execute in this manner, e.g., analyzing server nodes 104 and 106 and adding the “location” dimension and the “type” dimension to the set of dimensions, until the list of nodes is empty. It is noted that in this example, the last node to be added to the list of nodes is the server bank node 102. Thus, on the final iteration the server bank node 102 is analyzed. During this iteration, the dimension indexer module 306 determines that the dimensions explicitly defined in the server bank node 102 are an “owner” dimension and a “location” dimension. It is noted that when the dimensions of the server bank node 102 are merged with the set of dimensions, the “owner” dimension is added to the set of dimensions but the “location” dimension is not because a “location” dimension was added to the set of dimensions during the analysis of the server node 104. After analyzing the server bank node 102, the dimension indexer module 306 determines that the server bank node 102 has no parent nodes and that the list of nodes is empty.

Once the list is empty, the dimension indexer module 306 can return the set of dimensions to the requestor, as shown at operation 526. In the example provided above the dimension indexer module 306 can return a set of dimensions which includes a “name dimension,” a “distribution” dimension, a “performance” dimension, a “type” dimension, a “location” dimension, and an “owner” dimension. The set of dimensions pertaining to the particular type of node can be displayed to a user or can be used by the dimension indexer module 306 to update the dimension cache.

The method 500 described above is provided for example only and not intended to be limiting. The dimension indexer module 306 may implement other techniques or variations of the method 500 to determine the set of dimensions that pertain to a particular type of node.

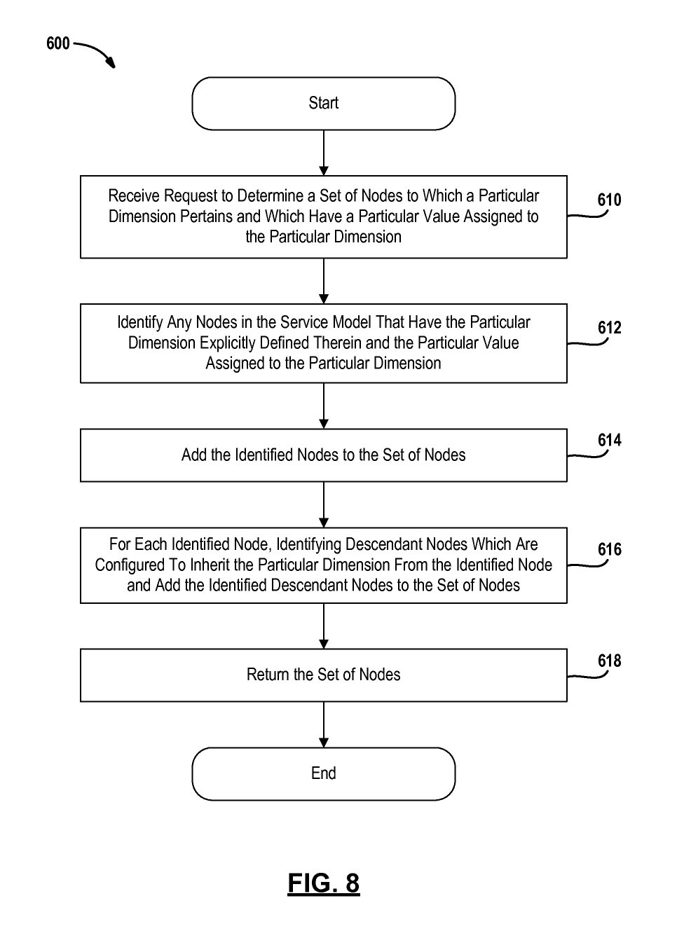

Referring now to FIG. 8, an example method 600 for responding to a request to determine a set of nodes to which a particular dimension pertains and which have a particular value assigned to the particular dimension. In some embodiments, the method 600 is performed by the dimension indexer module 306. For purposes of providing context to the description of the method 500, reference is made to the example service model 100 of FIG. 4. The dimension indexer module 306 may access the memory device 24 which stores the service model 100.

At operation 610, the dimension indexer module 306 receives the request to retrieve the set of nodes. The request may be received from, for example, a user via the reporting module 308. For example, the dimension indexer module 306 may receive a request for all nodes representing components which are “located” in Detroit Mich.

At operation 612, the dimension indexer module 306 identifies any nodes in the service model that have the particular dimension explicitly defined therein. The dimension indexer module 306 can obtain this information in any suitable manner. For example, the dimension indexer module 306 can identify the nodes in the service model 100 having the particular dimension explicitly defined therein from, for example, the dimension cache or by iteratively analyzing the service model 100 or the service model template 28. For each of these nodes, the dimension indexer module 306 can determine the value that is assigned (if any) to the particular dimension. If the value that has been assigned to the particular dimension of the node is equal to the particular value, the node is identified as belonging to the set of nodes. Referring to the example provided above, the dimension indexer module 306 identifies the server bank node 102, the server node 104, and the server node 106 as all having a “location” dimension explicitly defined therein. Only the server node 106, however, has the value “Detroit, MI” assigned to its location dimension. Thus, server node 106 is the only node that is identified during operation 612.

At operation 614, the dimension indexer module 306 adds the identified nodes to the set of nodes. Continuing the example provided above, server node 106 (or a pointer thereto) is added to the set of nodes.

At operation 616, the dimension indexer module 306 identifies descendant nodes of the identified nodes (identified at operation 612) which are configured to inherit the particular dimension. The dimension indexer module 306 can perform this operation iteratively by analyzing the descendant pathways of each of the identified nodes to determine which descendant nodes are configured to inherit the particular dimension. In some embodiments, a descendant node which has the particular dimension explicitly defined therein is not considered a node that inherits the particular dimension. Continuing the example provide above, the dimension indexer module 306 identifies the processor node 110, application node 112, and memory node 114 as the nodes that are configured to inherit from the server node 106. It is noted that memory node 114 inherits from the server node 106 by way of its dependency relationship with server node 106 and not by way of its component relationship with processor node 110.

At operation 618, the dimension indexer module 306 adds the identified descendant nodes to the set of nodes. In the example provided above, processor node 110, application node 112, and memory node 114 are added to the set of nodes.

Once the identified descendant nodes for all of the nodes identified in operation 612 are added, the dimension indexer module 306 can return the set of nodes to the requestor, as shown at operation 618. In the example provided above, the set of nodes that is returned to the requestor is server node 106, processor node 110, application node 112, and memory node 114. If the requestor is the reporting module 306, the dimension indexer module 306 may provide the set of nodes to the reporting module 308, which in turn displays the nodes to a user. In some scenarios, the dimension indexer module 306 may utilize the set of nodes to update one or more of the caches which it maintains.

The method 600 described above is provided for example only and not intended to be limiting. The dimension indexer module 306 may implement other techniques or variations of the method 600 to determine the set of nodes having a particular dimension pertaining thereto and a specific value assigned to the particular dimension.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A performance management tool that monitors performance of a computing infrastructure in a computing environment, comprising:
a service model that represents the computing infrastructure and resides in a data store, the service model being a hierarchical tree structure comprised of a plurality of linked nodes, each node in the tree structure representing a component of the computing infrastructure and having one or more properties of the component assigned thereto, each node further includes an inheritance rule which defines how properties assigned to other nodes are inherited by the component;
a service manager embodied as computer executable instructions executed by a computer processor and includes
a container module configured to receive a request to assign a given property to a given node in the tree structure and operable, in response to the request to update, to assign the given property to the given node in the tree structure; and
a dimension indexer module configured to receive a request for properties associated with a particular node and operable, in response to the request for properties, to retrieve properties for the particular node from the tree structure, including at least one property not assigned to the particular node but inherited from another node in the tree structure in accordance with the inheritance rule assigned the particular node.

2. The performance management tool of claim 1 wherein each node in the tree structure includes at least one type of relationship with each parent node and an inheritance rule for each type of relationship assigned to the node.

3. The performance management tool of claim 2 wherein the particular node has a component relationship with its parent node when the component represented by the particular node is a subcomponent of the component represented by the parent node.

4. The performance management tool of claim 2 wherein the particular node has a dependency relationship with its parent node when the component represented by the particular node is dependent on the component represented by the parent node.

5. The performance management tool of claim 2 wherein the particular node has a value expression relationship with its parent node when the values expressed in the parent node are derived from values of properties assigned to the particular node.

6. The performance management tool of claim 2 wherein the particular node has a user count relationship with its parent node when the amount of users which access the component represented by the parent node applied to the component represented by the parent node.

7. The performance management tool of claim 2 wherein the dimension indexer module is operable to traverse ancestral nodes of the particular node to retrieve properties associated with the particular node.

8. The performance management tool of claim 1 wherein the dimension indexer is configured to receive a request to nodes in the tree structure having a particular property and operable, in response to the request, to retrieve a listing of nodes having the particular property, including at least one node in the listing of nodes is identified using an inheritance rule.

9. The performance management tool of claim 1 wherein the component is further defined as at least one a software service or a device in the computing infrastructure.

10. A method for monitoring performance of a computing infrastructure of an enterprise, the method comprising:
a) maintaining, at a processing device of a computing device, a service model representing the computing infrastructure, the service model being a hierarchical tree structure comprised of a plurality of nodes, each node representing a component of the computing infrastructure and being of a type of a plurality of types, each type of node representing a different type of component, wherein one or more dimensions are explicitly defined within each node, each of the one or more dimensions defining a property of the component represented by the node in which the dimension is explicitly defined;
b) receiving, at the processing device, a request to determine a set of dimensions pertaining to a particular type of node in the computing infrastructure;
c) identifying, at the processing device, a set of nodes in the service model that are of the particular type;
d) adding, at the processing device, the set of nodes to a list of nodes;
e) merging, at the processing device, the dimensions explicitly defined in a given node with the set of dimensions;
f) identifying, at the processing device, any parent nodes of the given node from which the given node is configured to inherit dimensions from based on an inheritance rule;
g) adding, at the processing device, the identified parent nodes to the list of nodes; and
h) repeating, at the processing device, operations e-g for each node in the list of nodes.

11. The method of claim 10, wherein the components are each one of a service of the computing infrastructure and a device in the computing infrastructure.

12. The method of claim 10, wherein each child node in the tree structure includes at least one inheritance rule defined therein, wherein each child node has one or more parent nodes and each inheritance rule of each child node defines whether the particular node inherits dimensions pertaining to its one or more parent nodes.

13. The method of claiml2, wherein a root node of the plurality of nodes does not inherit dimensions from any other nodes in the tree structure, wherein the root node does not have any parent nodes.

14. The method of claim 12, wherein each child node has a relationship with each of its one or more parents defined by a relationship type.

15. The method of claim 14, wherein each inheritance rule defined in each child node indicates whether the child node inherits dimensions from its parent nodes having a particular relationship type with the child node.

16. The method of claim 10, wherein when the particular node inherits the dimensions pertaining to the one or more ancestral nodes, the dimensions pertaining to the one or more ancestral nodes are attributed to the particular node without being explicitly defined in the particular node.

17. The method of claim 10, wherein merging the dimensions explicitly defined in the given node with the set of dimensions includes, for each of the dimensions explicitly defined in the given node, adding the dimension to the set of dimensions only when the set of dimensions does not include a previously merged dimension which defines a same property as the dimension to be merged.

18. The method of claim 10, further comprising providing the set of dimensions for display to a user after operations e-g have been performed for each node in the list of nodes.

19. The method of claim 10, further comprising storing the set of dimensions in a cache after operations e-g have been performed for each node in the list of nodes, wherein when a subsequent request for the set of dimensions pertaining to the particular type of node is received, the set of dimensions is retrieved from the cache.

20. A method for monitoring performance of a computing infrastructure of an enterprise, the method comprising:
maintaining, at a processing device of a computing device, a service model representing the computing infrastructure, the service model being a hierarchical tree structure comprised of a plurality of nodes, each node representing a component of the computing infrastructure and being of a type of a plurality of types, each type of node representing a different type of component, wherein one or more dimensions are explicitly defined within each node, each of the one or more dimensions defining a property of the component represented by the node in which the dimension is explicitly defined and being assigned a value which represents the property of the component;
receiving, at the processing device, a request to determine a set of nodes in the service model to which a particular dimension pertains and having a particular value assigned to the particular dimension;
identifying, at the processing device, every node in the service model having the particular dimension explicitly defined therein and having the particular value assigned to the particular dimension;
adding, at the processing device, the identified nodes to the set of nodes; and
for each identified node:
a) identifying, at the processing device, every descendant node of the identified node which does not have the particular dimension explicitly defined therein and is configured to inherit the particular dimension from the identified node;
b) adding, at the processing device, each identified descendant node to the set of nodes.

21. The method of claim 20, wherein each node in the service model having at least one parent node has an inheritance rule defined therein.

22. The method of claim 21, wherein identifying every descendant node of the identified node is based on the inheritance rules defined in the descendant nodes.

23. The method of claim 21, wherein none of the nodes in the service model are configured to inherit from another node which is descendent therefrom.

24. The method of claim 20, further comprising providing, at the processing device, the set of nodes for display to a user.

25. The method of claim 20, further comprising storing the set of nodes in a cache, wherein when a subsequent request for the set of nodes to which the particular dimension pertains and which have the particular value assigned to the particular dimension is received, the set of nodes is retrieved from the cache.

26. The method of claim 25, wherein the cache is updated when a configuration change is made to the service model.

27. The method of claim 20, wherein the components are each one of a service of the computing infrastructure and a device in the computing infrastructure.
